(19) United States
(12) Patent Application Publication
(10) Pub. No.: US 2015/0280275 A1
(43) Pub. Date: Oct. 1, 2015

(54) BATTERY

(71) Applicant: KABUSHIKI KAISHA TOSHIBA, Minato-ku (JP)

(72) Inventor: Takahiro AIZAWA, Yokohama (JP)

(73) Assignee: KABUSHIKI KAISHA TOSHIBA, Minato-ku (JP)

(21) Appl. No.: 14/481,109

(22) Filed: Sep. 9, 2014

(30) Foreign Application Priority Data
Mar. 28, 2014 (JP) 2014-068546

(51) Int. Cl. H01M 10/04

(52) U.S. Cl. CPC H01M 10/0431

(57) ABSTRACT

A battery includes a container configured to contain therein an electrolytic solution, belt-like electrodes rolled up into a flattened shape in the longitudinal direction, and contained in the container, current collection tabs intermittently provided in the longitudinal direction in such a manner that a plurality of groups are formed by the rolling up, and extended in a direction perpendicular to the longitudinal direction of the electrodes, and a plurality of junction parts at each of which current collection tabs belonging to an identical group of the plurality of groups are joined to each other.

### CROSS-REFERENCE TO RELATED APPLICATION

This application is based upon and claims the benefit of priority from the prior Japanese Patent Application No. 2014-068546, filed Mar. 28, 2014, the entire contents of which are incorporated herein by reference.

### FIELD

Embodiments of the present invention relate to a battery.

### BACKGROUND

In recent years, a non-aqueous electrolyte secondary battery compatible with quick charge and high-power discharge, excellent in cycle performance, and suitable for an application to an onboard secondary battery to be mounted on a hybrid car or an electric vehicle, power storage secondary battery to be used for power leveling or the like is developed. Such a secondary battery has a structure in which electrode groups formed by rolling up a belt-like positive electrode and negative electrode into a flattened shape through a separator interposed between the electrodes, and electrolytic solution used to immerse the electrode groups therein are contained in a battery container. Further, at front and rear ends of the electrode groups, metallic foil serving as a current collector of the positive electrode, and metallic foil serving as a current collector of the negative electrode protrude in an overlapping manner by the rolling to form current collection tabs. Leads electrically connected with external terminals used to take out an electric current are connected to the current collection tabs. Each of the leads is connected to the metallic foil of each of the current collection tabs protruding from the front and rear ends of the power generation elements by ultrasonic bonding in a superposing manner.

A demand for a further increase in capacity of the battery is growing in the market. In order to increase the capacity of the battery, it is necessary to increase the number of electrode groups. For that purpose, it is necessary to increase the number of times of rolling up of the positive electrode, and negative electrode, and the number of current collection tabs at the parts at which the current collection tabs are connected to the leads increases. Accordingly, it is necessary to prevent the number of tabs to be bonded at a time from increasing, and sufficiently transmit ultrasonic vibration to all the tabs and leads. That is, a battery in which enhancement of the capacity of the battery, and securement of strength of ultrasonic bonding are made compatible with each other by joining the lead and tab to each other by ultrasonic bonding while securing the necessary bonding strength is required.

### BRIEF DESCRIPTION OF THE DRAWINGS

FIG. 1 is an exploded perspective view showing a battery according to a first embodiment.

FIG. 2 is an explanatory view showing a main part of a current collector incorporated in the battery in a spreading manner.

FIG. 3 is an explanatory view schematically showing a connection state of a current collection tab, and lead incorporated in the battery.

FIG. 4 is an explanatory view schematically showing a connection state of a current collection tab, and lead of a battery according to a second embodiment.

FIG. 5 is an explanatory view showing a current collector incorporated in the battery in a spreading manner.

FIG. 6 is an explanatory view schematically showing a connection state of a current collection tab, and lead according to a third embodiment.

FIG. 7 is a perspective view showing a battery according to a fourth embodiment.

FIG. 8 is an exploded perspective view showing the battery.

FIG. 9 is an explanatory view schematically showing the battery.

### DETAILED DESCRIPTION

A battery according to one embodiment includes a container configured to contain therein an electrolytic solution, belt-like electrodes rolled up into a flattened shape in the longitudinal direction, and contained in the container, current collection tabs intermittently provided in the longitudinal direction in such a manner that a plurality of groups are formed by the rolling up, and extended in a direction perpendicular to the longitudinal direction of the electrodes, and a plurality of junction parts at each of which current collection tabs belonging to an identical group of the plurality of groups are joined to each other.

Hereinafter, embodiments will be described below in detail with reference to the drawings.

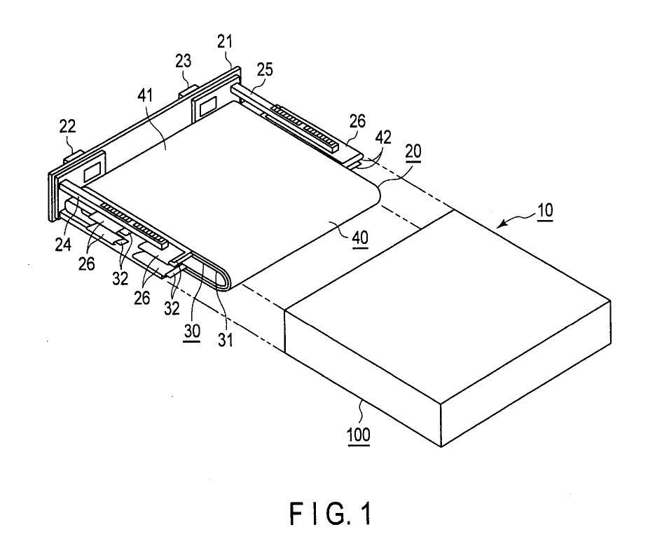

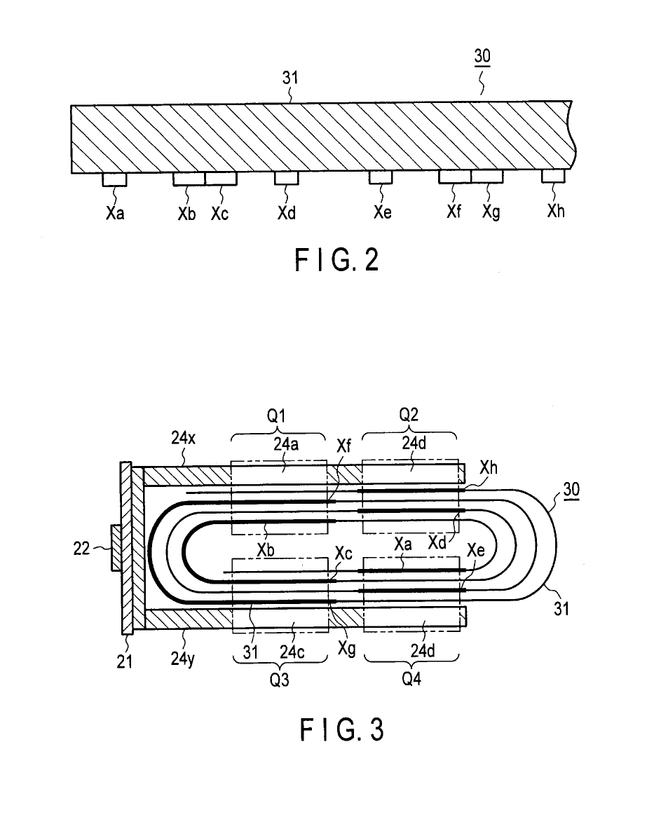

FIG. 1 is an exploded perspective view showing a battery 10 according to a first embodiment. FIG. 2 is an explanatory view showing a main part of a current collector incorporated in the battery 10 in a spreading manner. FIG. 3 is an explanatory view schematically showing a connection state of a current collection tab and lead incorporated in the battery 10.

The battery 10 is provided with a battery main body 20, and accommodation container 100 configured to contain therein the battery main body 20 together with an electrolytic solution, and formed of a metallic material (aluminum material, aluminum alloy or the like).

The battery main body 20 is provided with a lid body 21 configured to cover an opening part of the accommodation container 100, terminals 22, and 23 provided on the outer side of the lid body 21, and respectively connected to a positive electrode lead 24, and negative electrode lead 25 to be described later, stick-like positive electrode lead 24 (24x, 24y), and negative electrode lead 25 provided on the inner side of the lid body 21, and respectively connected to a positive electrode 30, and negative electrode 40 to be described later, and positive electrode 30, and negative electrode 40 rolled up into a flattened shape. The positive electrode 30, and negative electrode 40 are impregnated with an electrolytic solution.

The positive electrode 30 is provided with a current collector 31 formed by forming metallic foil made of aluminum, copper, or an alloy of these metals into a belt-like shape, and a surface of which is coated with a positive electrode material, and a plurality of current collection tabs 32 formed in such a manner that the tabs 32 protrude from the current collector 31 in a direction perpendicular to a longitudinal direction of the current collector 31. The plurality of current collection tabs 32 are intermittently provided in the longitudinal direction as shown in FIG. 2. The interval between the current collection tabs 32 will be described later.

The positive electrode 30 is rolled up into a flattened shape according to the shape of the container 100, whereby the plurality of current collection tabs 32 are positioned at one of two positions (first current collection tab group Q1, and second current collection tab group Q2) separate from each other in the longitudinal direction of the positive electrode lead 24x, and these are referred to as a first junction part 24a, and second junction part 24b. It should be noted that at the first junction part 24a, and second junction part 24b, conductive plate members 26a, and 26b are arranged respectively, and are joined to the current collection tabs 32 by ultrasonic bonding. These plate members 26a, and 26b are used to prevent the current collection tabs 32 from being misaligned or being damaged at the time of ultrasonic bonding.

The intervals at which the current collection tabs 32 are provided are set as shown in FIG. 2, and FIG. 3. That is, the current collection tabs 32 are arranged in such a manner that the current collection tabs 32 are alternately arranged at the first current collection tab group Q1, and second current collection tab group Q2, and are arranged in every other layer of lamination in the direction of lamination based on the rolling up of the positive electrode 30. When the positive electrode 30 shown in FIG. 2 is rolled up, a positional relationship shown in FIG. 3 is obtained. It should be noted that Xa to Xh in FIG. 2, and FIG. 3 indicate positions of the current collection tabs 32.

As described above, at the first junction part 24a, and second junction part 24b, the current collection tabs 32 are arranged in every other layer of lamination in the lamination direction, and hence the number of current collection tabs 32 to be bonded at a time becomes smaller (half) than the number of laminations in the lamination direction, and the ultrasonic bonding is made easier.

Likewise, regarding the other positive lead 24y, the current collection tabs 32 are arranged in such a manner that the current collection tabs 32 are alternately arranged at the first current collection tab group Q3, and second current collection tab group Q4, and are joined to each other at the first junction part 24c, and second junction part 24d by ultrasonic bonding.

The negative electrode 40 is formed in the manner identical to the positive electrode 30, and hence the detailed description thereof is omitted. It should be noted that the current collection tabs of the negative electrode 40 protrude in the direction opposite to the current collection tabs of the positive electrode 30, and are connected to the negative electrode lead 25 at two positions for one negative electrode lead.

According to the battery 10 of this embodiment, even when the number of times of rolling up of the positive electrode, and negative electrode constituting the electrode groups is increased in order to increase the capacity, it is possible to divide the number of current collection tabs 32 to be bonded at a time into halves, and hence ultrasonic vibration can be sufficiently transmitted to all the current collection tabs 32. Accordingly, it is possible to join the positive electrode lead, and current collection tabs to each other or join the negative electrode lead, and current collection tabs to each other by ultrasonic bonding, while securing the necessary bonding strength. Therefore, it is possible to make the enhancement of the capacity of the battery, and securement of strength of ultrasonic bonding compatible with each other.

It should be noted that in this example, although two current collection tab groups are employed, the number of groups may be more than or equal to two, if the number of groups is plural. It should be noted that when the number of the plurality of groups is n, the current collection tabs 32 are formed in such a manner that the current collection tabs overlap each other at the junction part every (n−1)th time of the rolling up.

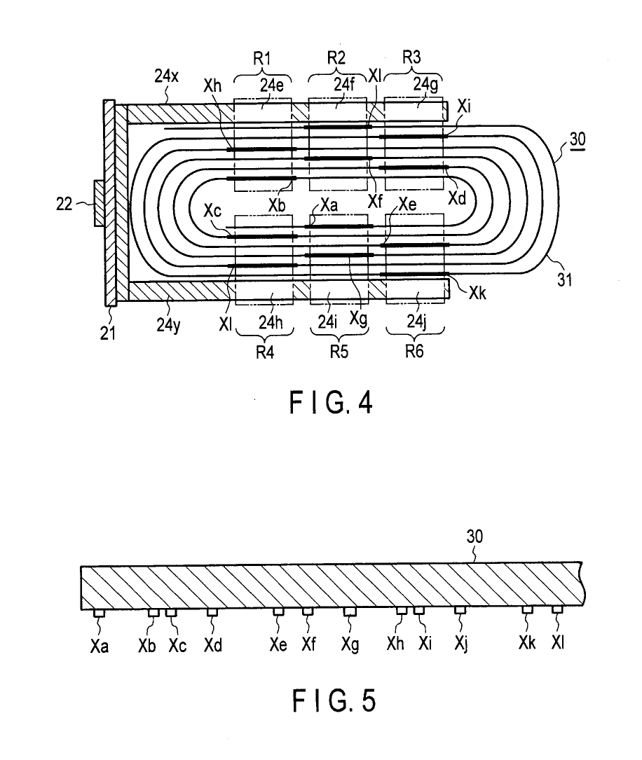

FIG. 4 is an explanatory view schematically showing a connection state of a current collection tab 32, and positive electrode lead 24 of a battery 10A according to a second embodiment, and FIG. 5 is an explanatory view showing a current collector incorporated in the battery 10A in a spreading manner. In FIGS. 4, and 5, functional parts identical to FIGS. 2, and 3 are denoted by identical reference symbols, and their detailed descriptions are omitted. It should be noted that Xa to Xm in FIGS. 4, and 5 indicate positions of current collection tabs 32.

In this embodiment, a plurality of current collection tabs 32 are positioned at one of three positions (first current collection tab group R1, second current collection tab group R2, and third current collection tab group R3) separate from each other in the longitudinal direction of the positive electrode lead 24x, and these are referred to as a first junction part 24e, second junction part 24f, and third junction part 24g. In this case, the number of bonding times of the current collection tabs becomes ⅓ of the number of laminations.

With the battery 10A according to this embodiment, it is possible to obtain an advantage identical to the battery 10 described previously, and the number of current collection tabs to be bonded at one position is reduced, and hence ultrasonic bonding is further facilitated.

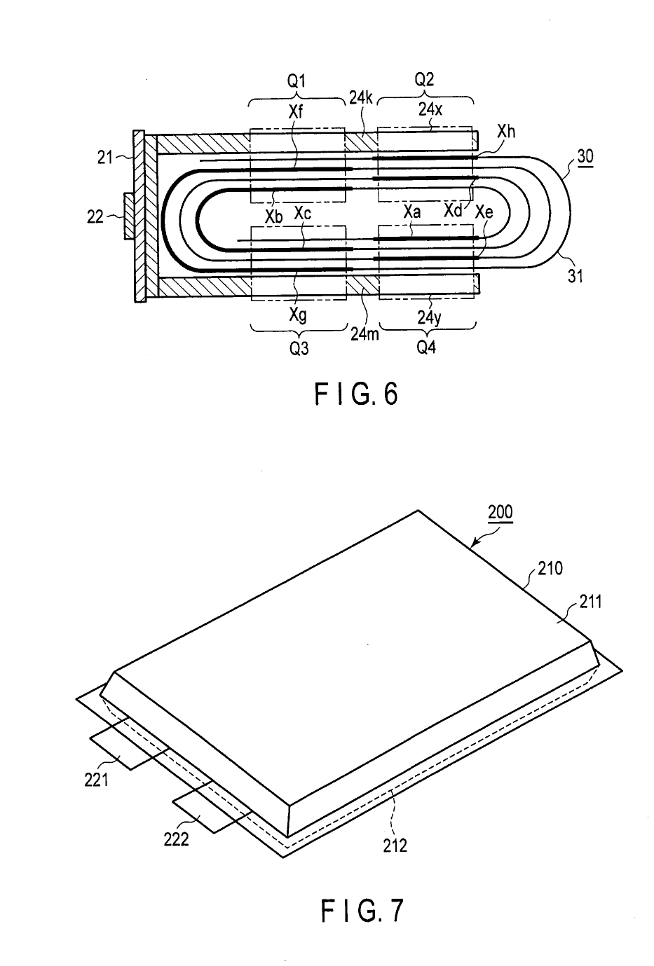

FIG. 6 is an explanatory view schematically showing a connection state of a current collection tab 32, and positive electrode lead 24 of a battery 10B according to a third embodiment. In FIG. 6, functional parts identical to

FIG. 3 are denoted by identical reference symbols, and their detailed descriptions are omitted.

In this embodiment, although a configuration approximately identical to the aforementioned battery 10 is employed, connection is carried out by ultrasonic bonding of one time common to the first current collection tab group Q1, and second current collection tab group Q2. It is possible to obtain an advantage identical to the case of the battery 10 where ultrasonic bonding is carried out for each of the first junction part 24a, and second junction part 24b, and improve the manufacturing efficiency.

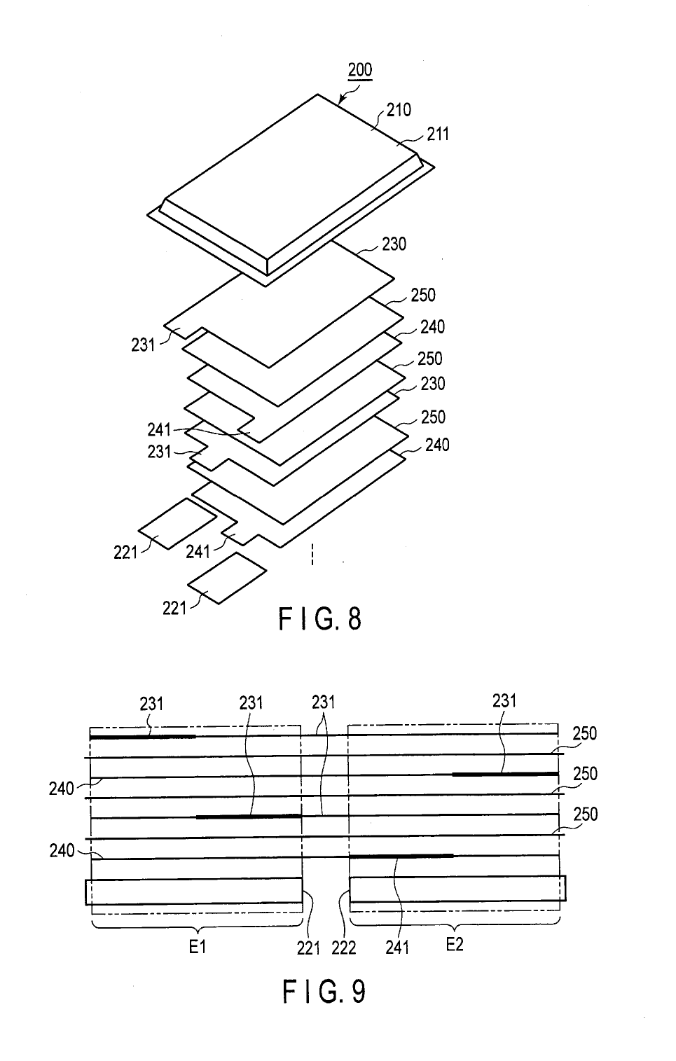

FIG. 7 is a perspective view showing a battery 200 according to a fourth embodiment. FIG. 8 is an exploded perspective view showing the battery 200. FIG. 9 is an explanatory view schematically showing the battery 200.

The battery 200 is battery of a laminate type, and is provided with a container 210 in which an electrolytic solution is contained, and battery main body 220 contained in the container 210 as shown in FIG. 7. The container 210 is formed by joining opening parts of a first exterior 211 of a box-like shape with a bottom, and second exterior 212 to each other. It should be noted that reference symbols 221, and 222 in FIG. 7 indicate terminal leads drawn out of the battery main body 220.

As shown in FIG. 8, in the battery main body 220, a plurality of positive electrodes 230, and negative electrodes 240 are arranged with separators 250 interposed between the positive electrodes 230, and negative electrodes 240. The positive electrodes 230 are provided with current collection tabs 231. As shown in FIG. 9, positions of the current collection tabs 231 are shifted from each other with respect to the positive electrodes 230 positioned above and below. On the other hand, below the positive electrode 230, a terminal lead 221 is arranged, and they are made integral with each other by ultrasonic bonding from above to below.

Likewise, the negative electrodes 240 are provided with current collection tabs 241. As shown in FIG. 9, positions of the current collection tabs 241 are shifted from each other with respect to the negative electrodes 240 positioned above and below. On the other hand, below the negative electrode 240, a terminal lead 222 is arranged, and they are made integral with each other by ultrasonic bonding from above to below. Each of reference symbols El, and E2 in FIG. 9 indicates a range to be joined at a time by ultrasonic bonding. The positions of the current collection tabs 231, and 241 are shifted from each other in the manner described above, and hence the number of current collection tabs to be laminated at the time of bonding becomes less than the number of the positive electrodes 230 or the negative electrodes 240 and, in this example, ½. Accordingly, ultrasonic bonding in the manufacturing process is made easier.

According to the battery 200 of this embodiment, it is possible to divide the number of current collection tabs to be bonded at a time into two even when the number of lamination layers of the positive electrode, and negative electrode constituting the electrode groups is increased in order to increase the capacity, and hence the ultrasonic vibration is sufficiently transmitted to all the current collection tabs. For this reason, it is possible to join the terminal lead, and current collection tabs to each other by ultrasonic bonding while securing the necessary bonding strength. Accordingly, it is possible to make the enhancement of the capacity of the battery, and securement of the strength of ultrasonic bonding compatible with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
a container configured to contain therein an electrolytic solution;
belt-like electrodes rolled up into a flattened shape in the longitudinal direction, and contained in the container;
current collection tabs intermittently provided in the longitudinal direction in such a manner that a plurality of groups are formed by the rolling up, and extended in a direction perpendicular to the longitudinal direction of the electrodes; and
a plurality of junction parts at each of which current collection tabs belonging to an identical group of the plurality of groups are joined to each other.

2. The battery according to claim 1, wherein when the number of the plurality of groups is n, the current collection tabs are formed in such a manner that the current collection tabs overlap each other at the junction part every (n−1)th time of the rolling up.

3. A battery comprising:
a container configured to contain therein an electrolytic solution;
belt-like electrodes arranged in the container in the longitudinal direction;
current collection tabs intermittently provided in such a manner that a plurality of groups are formed in the longitudinal direction of the electrodes, and extended in a direction perpendicular to the longitudinal direction of the electrodes; and
junction parts at each of which current collection tabs belonging to an identical group of the plurality of groups are joined to each other.
